(19) United States
(12) Patent Application Publication
(10) Pub. No.: US 2016/0224988 A1
(43) Pub. Date: Aug. 4, 2016

(54) SYSTEM AND METHOD FOR DATA QUALITY ASSURANCE, AUDITING, AND CERTIFICATION

(71) Applicant: GS1 US, Lawrenceville, NJ (US)

(72) Inventor: Mary Wilson, Lawrenceville, NJ (US)

(21) Appl. No.: 14/790,936

(22) Filed: Jul. 2, 2015

Related U.S. Application Data
(60) Provisional application No. 62/110,081, filed on Jan. 30, 2015.

(51) Int. Cl. G06Q 30/00

(52) U.S. Cl. CPC G06Q 30/018

(57) ABSTRACT

A method for certifying an organization as compliant with a data quality program includes providing one or more education sessions for an organization. The method also includes assessing the organization as to its product data quality, wherein assessing comprises determining a level of knowledge associated with the organization with respect to one or more of Global Trade Item Number (GTIN) allocation techniques, product measurement techniques, and data synchronization practices. The method also includes performing a physical audit of the organization's product data quality practices. The physical audit includes determining whether electronic product data stored by the organization is consistent with one or more physically observable characteristics of a product. The one or more physically observable characteristics include one or more of a brand name, a declared net content, a pack quantity, a product GTIN, a number of the product on a pallet, a country of origin, one or more dimensions of the product, and a gross weight of the product.

### TECHNICAL FIELD

This disclosure relates generally to information services and processing, and, more particularly, to a system and method for data quality assurance, auditing, and certification.

### BACKGROUND

Consumers have become more demanding in their purchasing decisions. From a consumer's perspective, having access to the right product at the right time, at the right price is paramount to their shopping experience—whether it is through traditional brick-and-mortar or on-line purchasing. With shrinking margins and increased competition, the ability to meet the consumer's needs in the most cost-efficient manner is important to retailers and e-tailers alike. The ability to service the customer in the manner they are demanding depends, in part, upon accurate and complete data. As the reliance on data increases, it is important that the data is timely as well as accurate. Despite years of attempting to improve the quality of data through various programs, the sentiment held by the industry is that a fresh approach should be taken on this important matter. The system of the present disclosure attempts to establish this new approach to data quality and data governance.

### SUMMARY

According to embodiments of the present disclosure, disadvantages and problems associated with previous systems may be reduced or eliminated.

According to another embodiment, a method for certifying an organization as compliant with a data quality program includes providing one or more education sessions for an organization. The method also includes assessing the organization as to its product data quality, wherein assessing comprises determining a level of knowledge associated with the organization with respect to one or more of Global Trade Item Number (GTIN) allocation techniques, product measurement techniques, and data synchronization practices. The method also includes performing a physical audit of the organization's product data quality practices. The physical audit includes determining whether electronic product data stored by the organization is consistent with one or more physically observable characteristics of a product. The one or more physically observable characteristics include one or more of a brand name, a declared net content, a pack quantity, a product GTIN, a number of the product on a pallet, a country of origin, one or more dimensions of the product, and a gross weight of the product.

### BRIEF DESCRIPTION OF THE DRAWINGS

For a more complete understanding of the present disclosure, reference is now made to the following description, taken in conjunction with the accompanying drawings, in which:

FIG. 1 illustrates a high-level framework for a process of certifying an organization as compliant with a data quality program;

FIG. 2 illustrates an example of the sample sizes that may be used during an audit for certifying an organization as compliant with a data quality program; and

FIG. 3 is a flowchart illustrating a method for certifying an organization as compliant with a data quality program.

### DETAILED DESCRIPTION

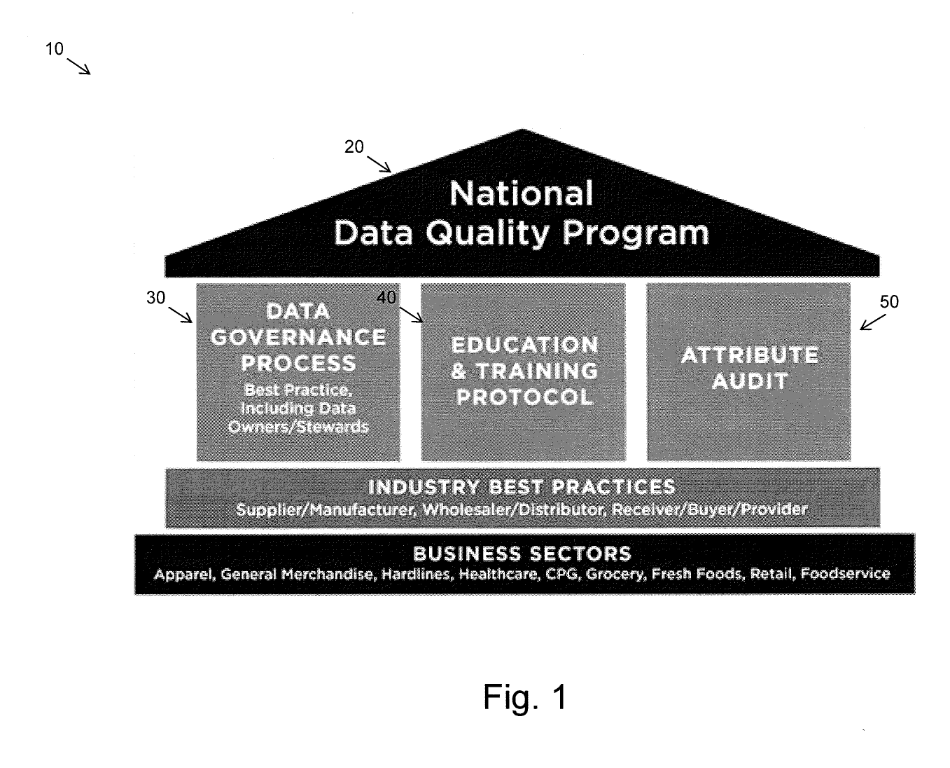

Embodiments of the present disclosure and its advantages are best understood by referring to FIGS. 1 through 3 of the drawings, like numerals being used for like and corresponding parts of the various drawings.

This disclosure is generally related to a process for facilitating high quality product data within an organization—that is, for facilitating consistency between electronically stored data about a product and the physically observable characteristics of the product (for instance, the size and/or weight of a product). In certain embodiments, best practices for facilitating data quality include the following steps: (1) adhering to GS1 Standards and Rules for initial attributes in internal setup; (2) assigning data owners throughout the organization; (3) appointing one entity/department/individual as the sole owner of product data; (4) auditing all new items produced in a sustainable production environment ready for shipment (finished goods); and (5) executing communication of initial attributes and product package measurements, both internally and externally.

This disclosure is also generally directed to a process for certifying that an organization complies with the best practices for product data quality. In certain embodiments, the certification process begins with an education and training protocol. At the conclusion of education and training, the organization may be assessed as to its knowledge on product data quality. These assessments may focus on GTIN (Global Trade Item Number) allocation techniques, product measurement techniques, and data synchronization practices.

In some embodiments, the next step in the certification process includes a physical audit of the organization's product data quality practices. The audit may focus on determining the degree that electronic product data stored by the organization is consistent with the physically observable characteristics of the product. Some of the characteristics tested during the physical audit may include brand name, declared net content, pack quantity, product GTIN, number of items on a pallet, country of origin, product dimensions (height, width, depth), and gross weight.

Any appropriate scoring system may be employed to determine whether an organization complies with data quality standards. As an example, if the organization scores 90% or higher during the physical audit, the organization may be certified as compliant with the GS1 U.S. National Data Quality Program. This certification may remain effective for any appropriate amount of time. As an example, a particular certification may be effective for three years, assuming the organization passes interim yearly audits of similar scope as the original physical audit.

FIG. 1 illustrates a framework 10 for a process of certifying an organization as compliant with data quality program 20. As illustrated, in certain embodiments, data quality program 20 provides organizations a comprehensive approach to data quality that encompasses: (1) data governance process 30—ensuring a data governance process exists within an organization that supports the creation and maintenance of product data based on GS1 Standards; (2) education and training protocol 40—confirming proper education and training on GS1 Standards within an organization for creating and maintaining accurate product data; and (3) attribute audit 50—auditing, verifying and comparing product attributes to most recently shared data to enable trading partners to have confidence that the data shared is accurate, complete and timely. Data quality program 20 provides companies serving more than one sector a common approach to data quality. Additionally, data quality program 20 may enable each industry to add additional components to address their industry specific challenges should the need arise.

Data quality program 20 may be designed to ensure organizations' internal data governance process 30 is documented and adhered to as well as demonstrate institutional knowledge of GS1 Standards such as the GTIN Allocation Rules and GDSN Package Measurement Rules by those individuals responsible for data quality. Data quality program 20 focuses on an assessment process which includes product attributes that are considered critical across all sectors as well as additional attributes if the community deems they are important to meeting their trading partners' needs.

In certain embodiments, data quality program 20 may be (1) based on user needs (e.g., suppliers and recipients of data); (2) voluntary as adherence to the program will be determined by the trading partner relationship; (3) comprehensive in its structure yet provides for flexible implementation, as required by the trading partners; (4) complementary to and evolves with changes to GS1 Standards; (5) based on a data quality industry protocol formed by two components: i) data inspection against product characteristics and ii) a data quality management procedure to validate the existence and effectiveness of key data management business processes; (6) based on an open system whereby entities may offer services for product attribute audits and certification assessments; open for use by any business entity; and (8) based on a standardized approach for attribute audits (e.g., utilizing the GS1 Package Measuring Rules, a set of Key Performance Indicators, and establishes a common sample size). Data quality program 20 accommodates small, medium and large enterprises.

In certain embodiments, trading Partners define data quality as having consistent, complete, accurate, standards-base, time-stamped data. Trading partners measure product data quality as “electronic data exchanged equals physical data.” Data quality reaches beyond accurate data—encompassing an overall program within an organization including components such as having executive leadership support, commitment to standards based data, and processes that ensure consistent, complete and accurate information is being captured and utilized for both internal processes and external sharing. This provides the foundation for an efficient supply chain and enables trading partner collaboration.

Data may originate from several sources including external vendors and internal departments. Without a robust business process in place, the quality of data may deteriorate as it flows through the supply chain. Due to the potential cost implications and requests from trading partners, many companies have started to scrutinize their internal processes and education practices regarding data quality, as well as performing audits of the information received from and shared among their trading partners. Common areas of review as part of education and training protocol 40 include master data governance, product measurement, GTIN management, and data synchronization.

Companies that have strong data management programs consistently follow industry best practices for continuity and consistency. These companies have documented processes that are shared throughout the organization. Five points referred to as the Five Point Best Practice can summarize the industry best practices for data quality: (1) adhere to GS1 Standards and Rules for initial attributes in internal setup; (2) assign data owners throughout the organization; (3) appoint one entity/department/individual as the sole owner of product data; (4) audit all new items produced in a sustainable production environment ready for shipment (finished goods); and (5) execute communication of initial attributes and package measurements, both internally and externally.

The foundation of the data quality program 20 is built upon the support of businesses from all industry sectors and supply chain roles and is considered best practice for launching and sustaining a best in class data quality program. As illustrated in FIG. 1, data quality program 20 offers suppliers the opportunity to become certified based upon three basic tenets, often referred to as criteria or pillars, of the program. The supplier is measured via a certification process consisting of three sections which represent the criteria or pillars. The certification has defined criteria and thresholds. A supplier should achieve a passing score in each criteria or pillar (e.g., data governance process 30, education and training protocol 40, and attribute audit 50) in order to achieve certification for data quality program 20.

The following paragraph describes an embodiment of data governance process 30. Verification of the data governance process 30 is comprised of an assessment designed to determine the degree of which people, processes, and procedures are in place within an organization to ensure quality data is maintained and shared across all necessary business entities. The following are components part of the process for assessing data governing process 30, in certain embodiments: Data Governance, Data Quality, GTIN Management, Product Management, Attribute Accuracy, Data Synchronization, and Training. Each section includes requests for documentation and/or additional questions that may be asked by an auditor. The documentation and preliminary responses may be provided to the auditor in advance of the on-site interview at the supplier's location. Assessment of data governance process 30 can serve as a tool to help a company determine whether they are ready to begin the certification process. In certain embodiments, the supplier may achieve a certain threshold score in order to “achieve” a “passing score” for the data governance process 30 to have it count towards certification. In certain embodiments, the threshold may be that the supplier should achieve a score of 90% to receive a passing score.

The following paragraph describes an embodiment of education and training protocol 40. In certain embodiments, an objective of education and training protocol 40 is to verify the comprehension and proper application of the GS1 System of Standards within the organization. Participants may provide evidence of who within the organization has been trained, and the method by which they keep current. This may be validated through an interview process as a part of the Data Governance assessment and a series of quizzes. In certain embodiments, the areas of focus for the assessments and quizzes may be GTIN Allocation, Product Measurement, and Data Synchronization (if applicable). An organization may ensure that all parties responsible for product data are part of an ongoing education program. Appropriate records of education, training, skills, and experience should be kept for each individual along with an evaluation of the effectiveness of the training. In certain embodiments this may help to identify instances where additional training may be useful. In certain embodiments, the supplier may achieve a certain threshold score in order to “achieve” a “passing score” for the education and training protocol 40 to have it count towards certification for the data quality program 20. In certain embodiments, the threshold may be that the supplier should achieve a score of 90% on each quiz and/or assessment to receive a passing score.

The following paragraphs describes an embodiment of attribute audit 50. In certain embodiments, attribute audit 50 encompasses a physical audit of identified product attributes, considered Key Performance Indicators (KPI's), compared to the information that is being shared with trading partners. Data quality program 20 identifies these common initial attributes (as determined by the user community) and groups them into two categories: Foundational and Fundamental attributes.

In certain embodiments, proof of an organization's capacity to produce and maintain good quality data lies within the product information itself. In addition, the quality of an organization's product information provides insight to internal challenges or opportunities within the organization's processes. An analysis of the data output of an organization will always offer clear indications of whether something is not quite right in data governance process 30.

Therefore, to measure the degree in which product information can be considered of good quality, a series of objective measures may be employed in certain embodiments. These measures expressed as Key Performance Indicators that can be periodically monitored to verify the actual accuracy of the data. Data accuracy KPIs are mostly related to the degree in which the product information stored in a repository is consistent with the physically observable characteristics of the trade item, and are also considered validation of adherence to the data governance process.

During innovation of a new item, key attributes are established which are considered “foundational”. Once shared with trading partners, any change made to these attributes should adhere to the GS1 GTIN Allocation Rules. The foundational attributes have been identified as Brand Name, Declared Net Content/Unit of Measure, Pack Quantity, and GTIN. For this purpose, in certain embodiments, “share” may be any method by which this information is communicated such as GDSN®, product catalogs, portals or sales sheets.

Fundamental attributes are those attributes that, in certain embodiments, do not necessarily need to adhere to the GS1 GTIN Allocation Rules when a change occurs during innovation. However, once in production, the GS1 GTIN Allocation Rules should be adhered to. The fundamental attributes have been identified as Linear Dimensions/Unit of Measure, Gross Weight/Unit of Measure, TI-HI (the number of cartons stored on a layer, or tier, (the TI) and the number of layers high that these will be stacked on the pallet (the HI)), and Country of Origin.

During the physical audit as part of attribute audit 50, each attribute may be physically reviewed for accuracy using certain criteria for each attribute. Certain embodiments and example criteria are presented below.

The Brand Name attribute may refer to the recognizable name used by a brand owner to uniquely identify a line of trade item or service. This is recognizable by the customer. In certain embodiments, the audit of Brand Name will consist of the brand name communicated matches what is physically on the product, the spelling being correct, and the brand name being consistent by product line. The audit may consist of visual inspection. The attribute audit 50 associated with the Brand Name attribute may use the following associated GTIN Allocation Rules: Rule 2.1 Brand, Rule 2.2 Brand Graphics, and Rule 2.3 Brand Addition.

The Declared Net Content/Unit of Measure (UoM) attribute may refer to the amount of the trade item contained in a package, as claimed on the label. In certain embodiments, the audit of Declared Net Content may consist of visual inspection of the published net content/UoM compared to the information being shared. An item will be audited if one of the following conditions exist: if the Consumer Unit Flag=Y, if the item is identified with a bar code and has a declared net content; even if the declared net content is not flagged to Y, or the information that is physically on the package is what should be communicated. For example, if the package says 16 oz., 1 lb. cannot be communicated. It should be noted that the supplier should strive to communicate all declared net contents. However, if only one is communicated it should be imperial. The declared net content shared should be present on the product.

The attribute audit 50 associated with the Declared Net Content/Unit of Measure (UoM) attribute may use the following associated GTIN Allocation Rules: Rule 4.1.2 Non-Declared Change (Net Weight, Count or Volume), Rule 4.1.3 Net Content Rule 4.1.6 Additional Net Content Unit Of Measure, and Rule 4.1.9 Marketing Declarations—New October, 2013.

The Pack Quantity attribute may refer to the information shared for each level of the hierarchy needs to match what is contained in the package. In certain embodiments, the audit of Pack Quantity may consist of visual inspection compared to the information being shared. For example, if a case has 2 inner packs both identified with a GTIN and each inner pack contains 4 eaches, the following Pack Quantity information should be stored: the Pack Quantity of Case=2; the Pack Quantity of the Inner Pack=4; and the Pack Quantity of the Each=1. As another example, if a case has 8 eaches (no inner pack), then the following Pack Quantity information should be stored: the Pack Quantity of the Case=8 and the Pack Quantity of the Each=1.

The attribute audit 50 associated with the Pack Quantity attribute may use the following associated GTIN Allocation Rules: Rule 4.1.1 Count of Items in a Pack, Rule 4.1.4 Contents of a Dynamic Assortment—Revised January, 2014, Rule 4.4.1 Random Packs—Revised January, 2014, Rule 4.4.2 Pre-Defined Assortment—Revised January, 2014, and Rule 4.5 Combination Pack—Revised July, 2013.

The Global Trade Item Number (GTIN) attribute may refer to a globally accepted 8, 12, 13, or 14-digit number that uniquely identifies products/trade items. In certain embodiments, the audit of the GTIN may consist of verifying the structure, uniqueness, and correctness of the GTIN. With regard to structure, the GTIN should be 14 digits, all numeric—independent of what is on the package (UPC/EAN, ITF, etc.). With regard to uniqueness, attribute audit 50 may ensure each level of the hierarchy has been assigned a unique number. Finally, for correctness, the GTIN on the item should match what is being shared. It should be noted that virtual GTINs may be subject to attribute audit 50 and thus should be published. A virtual GTIN may refer to a GTIN that has been assigned to a product but is not marked on the product.

The TI-HI attribute may refer to the number of cartons stored on a layer, or tier, (the TI) and the number of layers high that these will be stacked on the pallet (the HI). In certain embodiments, the audit may consist of visual inspection of the product compared to the data being shared, ensuring that the fields are populated, performing a reasonableness check (not 0, not 99 by 1, etc.), a process audit to verify there is a process in place to update the TI-HI if/when changes are made, and a physical count of number of cases for one layer (TI) as compared to the information being shared. Number of layers (HI) will not be audited as this can vary by customer and/or place of audit.

The attribute audit 50 associated with the TI-HI attribute may use the following associated GTIN Allocation Rules: Rule 3.3 New/additional pallet layout.

The Country of Origin attribute may refer to the country code (codes) in which the goods have been produced or manufactured. In certain embodiments, the audit will consist of comparing the information being shared to the information physically marked or on the product. If the Country of Origin is not marked on the product, it is not included in the data set for this KPI. If a product is produced in multiple countries, the human-readable component must match at least one.

The Linear Dimension Accuracy attribute may refer to the physical dimensions at all levels of the hierarchy have accurate and complete values for the dimensions listed below and are based on the GDSN Package Measurement Rules (including tolerances). The dimensions need to be associated with a valid Unit of Measure (UoM): Height, Width, and Depth. In certain embodiments, the audit of Dimension Accuracy may consist of the physical measurement of the product (with the tolerances applied) at all levels of the hierarchy compared to the information being shared and adherence to GDSN Package Measurement Rules (including tolerances).

The attribute audit 50 associated with the Linear Dimension Accuracy attribute may use the following associated GTIN Allocation Rules: Rule 3.1 Packaging With Major Impact, Rule 3.2.1 Packaging with Minor Impact, and Rule 3.2.2 Packaging—standard trade item grouping level.

The Gross Weight attribute may refer to the gross weight of the case. The gross weight includes all packaging materials of the trade item. The weight should be associated with a valid UoM.

In certain embodiments, the audit of Gross Weight may consist of the physical weighing of the product (with the tolerances applied) at the case.

The attribute audit 50 associated with the Gross Weight attribute may use the following associated GTIN Allocation Rules: Rule 3.1 Packaging With Major Impact, Rule 3.2.1 Packaging with Minor Impact, and Rule 3.2.2 Packaging—standard trade item grouping level.

The Overall Accuracy attribute refers to the combination of both the linear Dimension Accuracy and the Gross Weight KPI's. If any linear dimension or gross weight is inaccurate the case and its contents are considered inaccurate.

In certain embodiments, a supplier must achieve a score of 90% for Overall Accuracy for the Item and Case, Pack Quantity, Country of Origin, Declared Net Content, TI-HI, and Brand to “achieve” a “passing score” for the attribute audit 50. In certain other embodiments, other attributes and score thresholds may be used.

An example of a scoring system is present below. If a supplier scores between 70%-89% on the attribute audit, a reconciliation process may be provided and a second audit may be scheduled within 120 days. Submission for re-audit may be exception based. In certain embodiments, only the packaging type(s) that failed the audit will need to be submitted. The auditor is responsible for selecting the item(s). The supplier may be provided two or more opportunities to pass an audit. If the supplier fails the second (or additional) audit, the supplier will need to re-apply for certification.

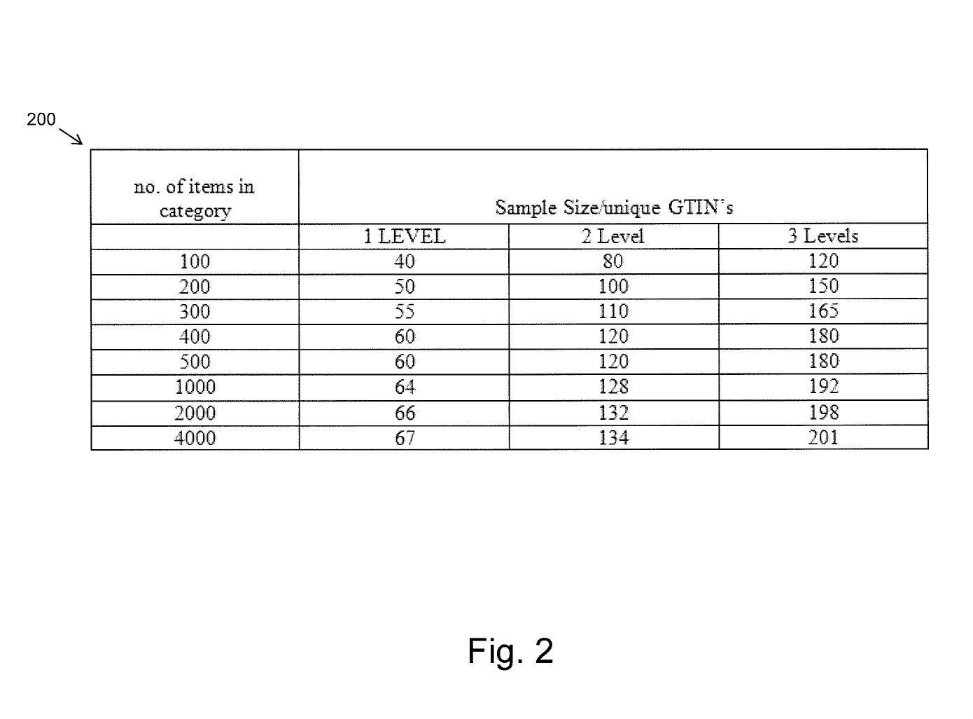

FIG. 2 illustrates an example of the representative sample size for which the certification of the Attribute Audit will be based upon. The actual sample size for each audit may vary by the number of items in a category and levels of hierarchy as illustrated in FIG. 2.

The sample size may be based upon 90% confidence rate and 10% confidence interval (margin of error). Other confidence rates and intervals may be used as necessary. In certain embodiments, the products to be audited will be selected by the auditing body and will be representative of the category and packaging types within. Detailed scorecard data is shared directly with the organization for which the assessment was conducted. Individual scores will not be shared beyond this use.

Certification for the data quality program 20 may be valid for a certain period of time (e.g., three years) with yearly interim audits. Following is the detail on how the program will be executed. There several options of how an organization can become certified depending upon its structure such as: Category, Business Unit, Business Process, or Business System. The supplier may determines how the organization will become certified (single category, all categories at once, etc.).

In certain embodiments, organizations with centralized business processes and business systems may only need to be certified once through the Data Governance Process Pillar. If an organization has disparate processes and systems, each process/system will need to be certified. Attribute audit 50 will be conducted by business unit and/or category to ensure a sample of all packaging types is audited and is based upon a representative sampling of new items and existing items.

After receiving certification, the following example timetable illustrates how a supplier may maintain its certification in certain embodiments:

Interim Attribute Audits:
Year 1: The sample will be representative of the top 20% of sales revenue plus new items.
Year 2: The sample will be representative of the top 50% of sales revenue plus new items.
Year 3: The sample will be representative of the entire portfolio.
Year 4: Recertification through all three components (data governance process, education and training protocol and attribute audit).

In the subsequent years, post the year four recertification; the sample for each interim audit will be representative of the entire portfolio. The audit sample size for the interim audits may be half the size of the initial audit. The premise being that once the supplier achieves initial certification, the subsequent audits serve to verify the data governance process and the education and training are still valid.

The interim attribute audit scoring remains the same as the initial certification audit wherein 90% must be achieved on the following attributes: Overall Case Accuracy (comprised of linear dimensions and gross weight at the case) at both the item and the case, Pack Quantity, Country of Origin, Declared Net Content, TI-HI, and Brand.

If a supplier scores between 70%-89%, a reconciliation process will be provided and a second audit is scheduled within 120 days. Submission for re-audit may be exception based. In certain embodiments, only the packaging type(s) that failed the audit will need to be submitted. The auditor is responsible for selecting the item(s). The same criteria to pass the audit applies as in the initial certification. The supplier is provided two opportunities to pass an interim audit. If the supplier fails the second audit, the supplier will need to re-apply for certification. Recertification is to be conducted every three years (occurs in year 4). The physical audits for recertification will take place at different facilities than the prior location (if possible). A methodology to allow Demand Side Trading Partners to provide feedback on accuracy of any Supplier's data may be determined.

If an organization fails an interim audit, certification will be revoked until such time they choose to reapply. In the subsequent years, post the initial certification cycle, the interim audits will be representative of the entire portfolio.

Organizations may have an opportunity to reconcile any concerns and submit back for certification within 60 days of the audit. If they are successful in the reconciliation of the issues, the score will be adjusted accordingly. If they are unsuccessful, it is up to the discretion of the supplier as to when they want to reapply for certification.

An organization will have the opportunity to appeal the results of the audit to GS1 US up to 30 days beyond the reconciliation process. If necessary, additional assessments will be held to resolve the appeal. If the appeal is successful there will not be incremental cost to the supply side partner.

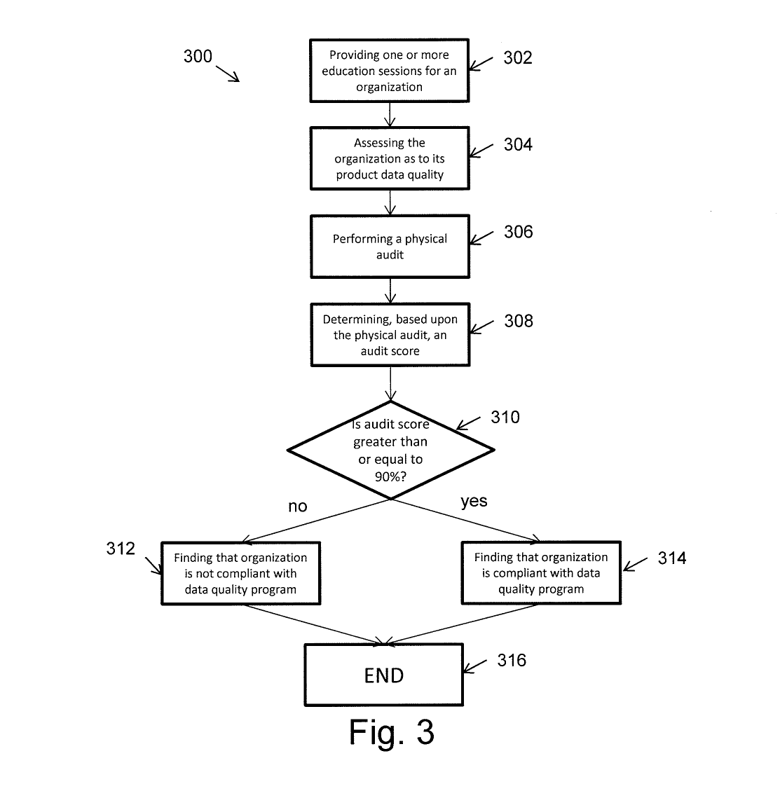

FIG. 3 illustrates an example flowchart illustrating a method 300 for certifying an organization as compliant with a data quality program. Method 300 begins at step 302 by providing one or more education sessions for an organization, for instance through education and training protocol 40.

The method continues to step 304 by assessing the organization as to its product data quality, for instance through assessing the data governance process 30 of an organization. As described above, assessing the organization may include determining a level of knowledge associated with the organization with respect to one or more of Global Trade Item Number (GTIN) allocation techniques, product measurement techniques, and data synchronization practices.

The method continues at step 306 by performing a physical audit like attribute audit 50 of the organization's product data quality practices. As described above, the physical audit may include the steps of determining whether electronic product data stored by the organization is consistent with one or more physically observable characteristics of a product. These physically observable characteristics may include a brand name, a declared net content, a pack quantity, a product GTIN, a number of the product on a pallet, a country of origin, one or more dimensions of the product, and a gross weight of the product.

The method continues at step 308 by determining, based upon the physical audit, an audit score. At step 310, the method continues by determining if the audit score is greater than or equal to 90%. If the score is less than 90%, the method continues to step 312 where the organization is found as not being compliant with data quality program 20. If the score is greater than or equal to 90%, the method continues to step 314 with certifying the organization as compliant with data quality program 20. The method ends at step 316.

The following glossary provides additional examples and details for certain embodiments of this disclosure:

Brand Name: The recognizable name used by a brand owner to uniquely identify a line of trade item or services. This is recognizable by the consumer. This is the brand on the package, not the name of the owner of the brand.

Certification Program: A systemic process used to determine the work behaviors and curriculum for a defined position and to provide the corresponding assessment tools, along with the mechanisms for tracking compliance, candidate verification, recertification and security of data.

Country of Origin: The country code (codes) in which the goods have been produced or manufactured.

Data Governance: A process to manage the actions, methods, timing, and responsibilities for supporting master data within an organization.

Data Owner: An individual within an organization that is accountable for written control mechanisms documenting GTIN validation procedures. This person should be familiar with the GTIN allocation rules.

Data Steward: This individual is the subject matter expert for the attributes most closely tied to their role in the company (i.e. packaging engineer owns packaging measurements and weights; marketing owns the assignment of brand name) and responsible for ensuring all aspects of the data is completed. This person should be intimately familiar with the GTIN allocation rules.

Data Synchronization: The process of sharing data between trading partners.

Declared Net Content/Unit of Measure: The amount (size or total) of trade item contained by a package usually as claimed on the label (i.e. 10 lbs of potatoes in a bag, or 2 each of watermelons in a case).

Depth: Depth is defined in terms of a consumer trade item and non-consumer trade item: Consumer Trade Item—the distance from the default front to the back, Non-Consumer Trade Item—the longer side of the natural base of the trade item,

Dimension Accuracy: The physical dimensions at all levels of the hierarchy have accurate and complete values for the dimensions listed below and are based on the GDSN Package Measurement Rules (including tolerances). The dimensions need to be associated with a valid Unit of Measure (UoM).

Electronic Data Interchange (EDI): The computer-to-computer exchange of structured information, by agreed message standards, from one computer application to another by electronic means and with minimal human intervention.

Foundational Attribute: Attributes that require a new GTIN assignment once the GTIN is shared with a trading partner and have been changed independent of which stage in the product development process (Pre-production or production) with adherence to the GS1 GTIN Allocation Rules.

Foundational Attributes include: Brand Name, Declared Net Content/Unit of Measure, GTIN, Pack Quantity.

Fundamental Attribute: Attributes not requiring a new GTIN assignment if a change occurs only in the pre-production stage. Once in production, the GS1 GTIN Allocation Rules must be followed. Fundamental attributes include: Dimensions—Case Level (length/width/height), Dimensions—Inner Pack (if shared/applicable), Dimensions—Item Level (if shared/applicable), TI/HI, Country of Origin, Gross Weight/UoM.

GDSN Package Measurement Rules: Rules for the global, unambiguous definition of nominal measurement attributes of product packaging to facilitate communication of the same for retail and non-retail products from the consumer unit to the case level and all intermediate packaging levels in between.

Global Data Synchronization Network (GDSN): The GS1 Global Registry and a network of interoperable, certified Data Pools that enable data synchronization per GS1 System Standards

Global Standards Management Process (GSMP): The document development lifecycle that includes a comprehensive set of rules allowing GS1's community of stakeholders to reach consensus on user-driven standards.

Global Trade Item Number (GTIN): The format in which Global Trade Item Numbers (GTIN's) must be represented in a 14 digit reference field (key) in computer files to ensure uniqueness of the identification numbers.

GS1 Global definition: A particular Global Trade Item Number, a numerical value used to uniquely identify a trade item. A trade item is any trade item (trade item or service) upon which there is a need to retrieve pre-defined information that may be planned, priced, ordered, delivered and/or invoiced at any point in any supply chain.

Gross Weight: Gross weight includes all packaging materials of the trade item. At pallet level the trade item includes the weight of the pallet itself. The weight has to be associated with a valid UoM.

GTIN Allocation Rules: GTIN Allocation, and the bar coding of the GTIN, is a technical process the rules for which are laid down in the GS1 General Specifications.

Harmonization: The practice of calculating product dimensions by using one of the following methods: 1) One item having several varieties is packaged the same. The item is measured and the dimensions are applied to all of the varieties of the same size. 2) An item is measured at the lowest level (ex. Each) and the subsequent levels are calculated based upon the number of “eaches” at each level throughout the hierarchy.

Height: Height is defined in terms of a consumer trade item and non-consumer trade item: Consumer Trade Item—The distance from the default front base to the top; Non-Consumer Trade Item—The measure of the trade item from the natural base to the top.

Initial Attributes: Key item attributes established across all industry verticals to respect the GTIN Allocation Rules. They are further categorized into Foundational and Fundamental attributes.

Internal Setup: The period of time prior to initial production; also referred to as innovation or concept phase.

Master Data Governance Entity: An individual or group which is responsible for data governance and held accountable for the quality of the data.

Pack Quantity: The information shared for each level of the hierarchy needs to match what is contained in the package.

Publish: Sharing product information primarily through the GDSN.

TI-HI: The number of cartons stored on a layer, or tier, (the TI) and the number of layers high that these will be stacked on the pallet (the HI).

Width: Width is defined in terms of a consumer trade item and non-consumer trade item: Consumer Trade Item—the distance from the default front left to right; Non-Consumer Trade Item—The shorter side of the natural base of the trade item.

UoM: Unit of Measure

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for certifying an organization as compliant with a data quality program, comprising:
providing one or more education sessions for an organization;
assessing the organization as to its product data quality, wherein assessing comprises determining a level of knowledge associated with the organization with respect to one or more of Global Trade Item Number (GTIN) allocation techniques, product measurement techniques, and data synchronization practices;
performing a physical audit of the organization's product data quality practices, wherein the physical audit comprises determining whether electronic product data stored by the organization is consistent with one or more physically observable characteristics of a product, wherein the one or more physically observable characteristics comprise one or more of a brand name, a declared net content, a pack quantity, a product GTIN, a number of the product on a pallet, a country of origin, one or more dimensions of the product, and a gross weight of the product;
determining, based upon the physical audit, an audit score; and
if the audit score is greater than or equal to 90%, certifying the organization as compliant with a data quality program.

2. A method of maintaining product data quality, comprising:
determining, within an organization, one or more rules for allocating initial attribute data to one or more products;
determining one or more owners of the initial attribute data associated with the one or more products;
auditing the one or more products that are ready for shipment to determine whether the initial attribute data associated with the one or more products is consistent with one or more physically observable characteristics associated with the one or more products; and
communicating one or more of the initial attribute data, additional data associated with the one or more products, and product package measurements to one or more first entities inside the organization and to one or more second entities outside the organization.
